(19) United States
(12) Patent Application Publication
(10) Pub. No.: US 2009/0102661 A1
(43) Pub. Date: Apr. 23, 2009

(54) WIRELESS ASSET IDENTIFICATION AND LOCATION

(76) Inventors: Sharon Ann Barnes, Kelowna (CA); Marty Charles Brooks, Kelowna (CA); Susan Joanne Derickson, Westbank (CA); John Liam Fitzpatrick, Kelowna (CA)

Correspondence Address: A PATENT LAWYER CORP, PLC;R WILLIAM GRAHAM, 22 S ST CLAIR ST, DAYTON, OH, 45402, US

(21) Appl. No.: 12/294,056

(22) PCT Filed: Jan. 4, 2007
(86) PCT No.: PCT/CA07/00019

§ 371 Date: Sep. 23, 2008

Related U.S. Application Data
(60) Provisional application No. 60/784,592, filed on Mar. 23, 2006.
(60) Provisional application No. 60/784,593, filed on Mar. 23, 2006.

(51) Int. Cl. G08B 13/14

(52) U.S. Cl. 340/572.1

(57) ABSTRACT

Asset identification and locating systems comprising a plurality of reference location tags and a plurality of asset identification tags, each reference location and asset identification tag having: a transceiver which can control the range of the tag; a unique tag identification number; a plurality of asset identification and locating retrieval units connected to a network, wherein each asset identification and locating retrieval unit will send and/or receive signals from the asset identification and reference location tags.

### FIELD OF THE INVENTION

The present invention relates to the identification of the location of an asset. In particular, the invention relates to the identification of the location of an asset wherein data is collected from a wireless tag placed on the asset and in communication with other wireless tags with known locations.

### BACKGROUND TO THE INVENTION

In many situations, the locating of assets within a facility is cumbersome and time-consuming because of the lack of information regarding the location of the asset. A loss in productivity occurs because workers are required to spend time searching for assets. When these assets are equipment, the utilization time and thus the benefit of the equipment is reduced. When these assets are works in progress or finished goods, delays may occur that cause product to be shipped late to customers.

To relieve the inefficiencies inherent in having individuals search for assets, many organizations will have asset-locating systems installed. An asset-locating system is a system where asset locations are continually updated in a real-time or near real-time manner. These systems typically include indicia affixed or attached in some manner to the asset. One such indicium is a radio frequency identification (RFID) tag. These systems typically make use of a network of fixed-point receivers, or interrogators, which either receives data from tags that are continuously transmitting or interrogate tags at a regular interval.

One key problem with this type of system is the cost of implementing the infrastructure necessary to make this system work. Where the size of the facility is extensive, this cost can be sufficiently high enough as to make the system not feasible.

A second problem with this type of system is that radio frequency signals are subject to multi-path events in metallic environments. The result is that the reliability of the signal is reduced as the distance between the transmitting object and the receiving object increases. To reduce the distance between tags and receivers, it is necessary to add more interrogators, thus increasing the cost of the infrastructure.

A better solution to is to introduce the use of reference location tags. Once such system is disclosed in U.S. Pat. No. 6,600,418 to Francis et al. Francis et al. discloses the use of a RFID tag on both the asset and in strategic fixed locations. A palette truck for moving objects includes an interrogator that records both the location and identification of the asset (using the RFID tag on the asset). By using the RFID tags from the fixed locations and the asset, the location of the asset can be stored in a database on the palette truck.

One problem with the system in Francis et al. is that the interrogator is located on a palette truck. This limits the ability of the system where the assets are not being moved by a palette truck or other such piece of moving equipment.

Another system is disclosed in U.S. Pat. No. 6,154,139 to Heller. The system makes use tags that transmit radio frequency (RF) and infrared (IR) to locate subjects. This implementation requires line-of-sight communication between the tag and an IR receiver to determine location, which is impractical in many facilities.

Another system includes U.S. Patent Publication No. 2006/0012480 to Klowak. Klowak discloses the use of location tags and mobile asset location retrieval systems. The system makes use of location tags that periodically transmit their identification. Asset tags in the system record the last location tag that was identified and transmit this identification along with their own identification periodically. Mobile asset location retrieval systems receive these periodic transmissions when they are in range during the transmission. One problem with this system is that the retrieval system is mobile. Because this device is not present in the area at all times, there may be many times where the asset is moved and an extended period of time passes before the location data is updated. Additionally, many environments do not have mobile devices that travel in patterns that would permit the collection of location data in regular or reasonable intervals.

A second problem of Klowak is that the asset tag determines location based on the last communication with a location tag. No provision exists for determining the distance from a location tag or for collecting information from more than one location tag. In open environments, there may be multiple location tags detected that are at varying distances from the asset tag.

### SUMMARY OF THE INVENTION

The present invention provides an asset location system in which the infrastructure costs are reduced compared to asset location systems that do not make use of mobile interrogators. The present invention also provides an asset location system that provides more accurate location information from location tags as compared to systems where location tag and asset tag information are both sent to the same receiver or interrogator.

The present invention provides for a method for collecting data from wireless tags. A plurality of wireless tags each capable of transmitting and receiving data and each identified by a unique identification code is provided. A first one of the wireless tags transmits data, with at least one other one of the wireless tags receiving the data and responding by transmitting further data including information relating to its unique identification code. The first wireless tag receives the further data and transmits still further data including information relating to the unique identification code of the first wireless tag and information relating to the unique identification codes of each of the responding wireless tags. A receiving unit receives the still further data.

In another aspect, the present invention provides for a method for determining the location of a subject wireless tag capable of transmitting and receiving data. At least one other wireless tag capable of transmitting and receiving data and identified by an unique identification code is provided. The subject wireless tag transmits data, with the at least one other wireless tag receiving the data and responding by transmitting further data including information relating to its unique identification code. The subject wireless tag receives the further data and transmits still further data including information relating to the unique identification codes of each of the at least one other wireless tag. A receiving unit receives the still further data and processes the still further data to determine the location of the subject wireless tag.

In yet another aspect, the present invention provides for a location tracking system for wireless tags. The system includes a wireless tag capable of transmitting and receiving data. It also includes at least one other wireless tag capable of receiving data from the wireless tag and transmitting data to the wireless tag, wherein the data transmitted to the wireless tag by each of the at least one other wireless tag comprises information relating to the identification of each the at least one other wireless tag and information relating to the signal strength between the wireless tag and each of the at least one other wireless tag. The system further includes a receiving unit capable of receiving data from the wireless tag, wherein the data received from the wireless tag comprises information relating to data received by the wireless tag from each the at least one other wireless tag. There is also a processing means to compute the location of the wireless tag from the data received by the receiving unit.

In yet another aspect, the present invention provides for a wireless tag for a location tracking system. The wireless tag includes a transmitter operable to transmit initial data to at least one other wireless tag and operable to transmit accumulated data to a receiving unit, wherein the accumulated data comprises information relating to the identification of the at least one other wireless tag and information relating to the signal strength between the wireless tag and the at least one other wireless tag. It also includes a receiver operable to receive response data from each of the at least one other wireless tag, wherein the response data comprises information relating to the identification of each of the at least one other wireless tag and information relating to the signal strength between the wireless tag and each of the at least one other wireless tag. It further includes a controller comprising a means to cause the transmitter to begin transmission of the initial data and a processor to transform the response data received by the receiver from each of the at least one other wireless tag into the accumulated data.

### BRIEF DESCRIPTION OF THE DRAWINGS

The present invention will be better understood with reference to the drawings in which:

FIG. 1 is a schematic plan view of an example of the implementation of an asset location system according to the present invention; and

FIG. 2 is a description of a locating communications sequence

FIG. 3 is a flowchart of events in a location communication.

FIG. 4 is a state transition diagram for the tag.

FIG. 5 is a block diagram of the tag.

FIG. 6 is a block diagram of the interrogator.

### DETAILED DESCRIPTION OF THE DRAWINGS

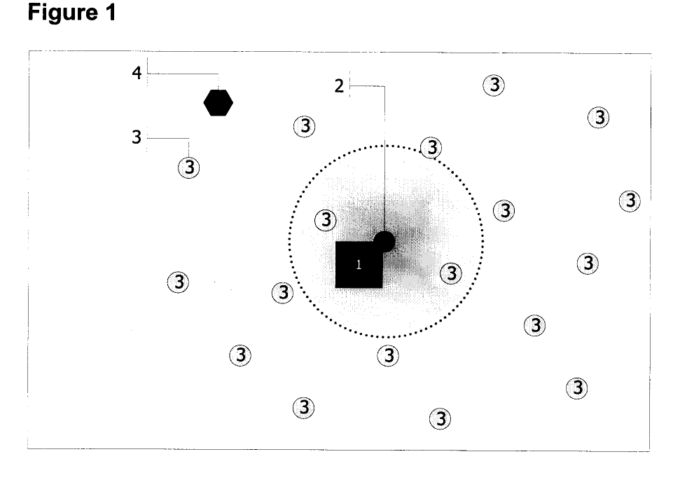

Reference is now made to FIG. 1. Within this system there are a plurality of reference location tags 3. The reference location tags 3 are either tags that are attached to a fixed point within the facility, such as a pole or wall, or asset tags whose locations have been determined and are now performing as a reference location tag. Also within this system are one or more interrogators 4 and one or more asset tags 2 affixed to an asset 1. Reference location tags 3 are located at known points within the environment. They may be attached to either fixed points within the environment or other assets with known locations. Asset tags 2 are affixed to the asset 1, which may be in motion part of the time. Once the location of the asset tag 2 becomes known in the system, the asset tag 2 may behave as a reference location tag 3. Interrogators 4 may be affixed permanently to a single fixed location or attached to an object that is in motion part of the time.

In this instance, the asset tags 2 and reference location tags 3 within the system have been equipped with an accelerometer to permit the triggering of the locating communications sequence. In another instance, the trigger for this sequence may be a sensor, such as a temperature sensor, or a sensor for detecting RF communication from an external source. In this instance, the asset 1 has entered the area and been put down within the area. The accelerometer on the asset tag 2 has detected that the asset tag 2 has come to a complete stop and initiates the locating communications sequence. A transmission requesting responses is made to the reference location tags 3 within the range of the asset tag 2. The distance or range of this communication is based on the transmit power set on the asset tag 2. Ideally, the transmit power will be set such that a minimum of three reference location tags 3 will be expected to be within range of the asset tag 2 wherever it stops within the area. Preferably, the data transmitted by the asset tag 2 includes a unique identification code of the asset tag 2. Such unique identification code may be a number. In another instance, additional data regarding other properties of the asset tag 2 may be transmitted.

The reference location tags 3 that detect the request from the asset tag 2 will transmit a response. The responding transmission will preferably be sent using an anti-collision algorithm to prevent interference among transmissions from multiple reference location tags 3 occurring at the same time. The data that a reference location tag 3 transmits to the asset tag 2 may include the unique identification code of the asset tag 2 that sent the message, the signal strength of the message that was received from the asset tag 2, and the unique identification code of the reference location tag 3. In another instance, further data may be transmitted as well. This data may include sensor values, such as battery voltage or temperature, timing data, or signal quality data about the received transmission from the asset tag 2.

After the asset tag 2 has received responses from the reference location tags 3, it will transmit the accumulated data to the interrogator 4. The transmit power used by the asset tag 2 for the tag-to-interrogator communications may be at a different power level than that used for tag-to-tag communications. Also, the frequency used for tag-to-interrogator communications may be different than that used for the tag-to-tag communications.

The interrogator 4 will then transmit the data to a backend system where it will be processed using an appropriate location computing algorithm. One such location computing algorithm is the LANDMARC algorithm developed by Lionel M. Ni, Yunhao Liu, Yiu Cho Lau, and Abhishek P. Patil. The location computing algorithm will coordinate all received information and using said information, determine the actual location of the asset tag. The algorithm requires at least one reference location tag response to determine the location of the asset tag 2. The accuracy of the algorithm is dependent on the number of reference location tag responses received. Ideally, there will be three or more reference location tag responses. Several weighting factors are used in the calculation including, but not limited to, signal strength, link quality, number and/or location of reference location tag locations reported, other reported attributes, and number and/or location of interrogators where signals were received.

In another embodiment of the system, the communications between the asset tag 2 and the reference location tags 3 may follow a different pathway. For example, the communications may follow a path from the asset tag 2 to the reference location tags 3 and then from the reference location tags 3 directly to the interrogator 4. Another possible embodiment would have the asset tag 2 communicate with the reference location tags 3 and receive the responses from the reference location tags 3. This communication sequence would be repeated several times prior to the asset tag 2 transmitting the resulting data to the interrogator 4.

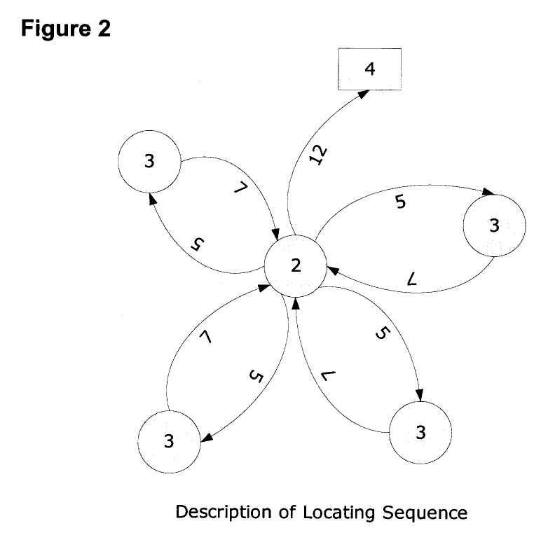

Reference is now made to FIG. 2, depicting the typical communications path of the locating communications sequence. In this instance, the asset tag 2 initiates the locating communications sequence by transmitting (shown as 5) a message at the power level and on the frequency configured for tag-to-tag communications. All of the reference location tags 3 that detect the message from the asset tag 2 transmit (shown as 7) a response using the transmit power level and frequency configured for tag-to-tag communications. The asset tag 2 then transmits (shown as 12) data to the interrogator 4, the data preferably comprising the responses from the reference location tags 10. The transmit power and frequency used for such tag-to-interrogator communications may be the same or different from that used for tag-to-tag communications.

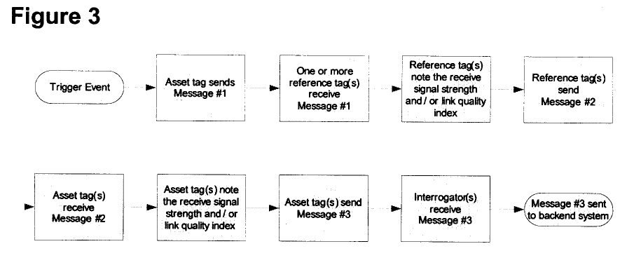

Reference is now made to FIG. 3. The asset tag 2 transmits a message requesting a response from the reference location tags 3 that receive the message (hereinafter referred to as Message #1). This message preferably contains the unique identification code of the asset tag 2 that is sending the message.

The reference location tags 3 that receive Message #1 may identify the signal strength and/or the link quality index of the message received. The reference location tags 3 will then transmit a message (hereinafter referred to as Message #2) back to the asset tag 2. The responding transmission will preferably be sent using an anti-collision algorithm to prevent transmission of messages from multiple reference location tags 3 at the same time. Message #2 may contain the receive signal strength and/or the link quality index of the Message #1 transmission. Message #2 preferably contains the unique identification code of the asset tag 2 that sent Message #1. Additionally, Message #2 may contain additional data such as sensor data (temperature, battery voltage, or other data), data from counters (timers, number of transmissions or other counters), or data from the contents of user memory.

The asset tags that receive Message #2 may also identify signal strength and/or the link quality index of the message received. Depending on the configuration of the system, the asset tags that receive Message #2 but did not initiate this message may discard the message in its entirety. The asset tags that retain Message #2 will then send a message (hereinafter referred to as Message #3) to the interrogator 4. Message #3 may contain the identification code of all reference location tags 3 that sent Message #2. Message #3 may contain the receive signal strength and/or link quality index of Message #1, the receive signal strength, the link quality index of Message #2, and/or the identification code of the asset tag 2 that sent Message #1. Additionally, Message #3 may contain additional data such as sensor data (temperature, battery voltage, or other data) and/or data from counters (timers, number of transmissions, or other counters) or user memory as reported in Message #2 or added to Message #2.

The interrogator 4 receives Message #3 and transmits the contents of this message to a backend system through one or more of several interfaces. These interfaces may include serial, cellular, Ethernet, and/or 802.11. Other appropriate interfaces may also be used. Preferably, the interrogator 4 will not respond or react to Message #1 or Message #2.

In another embodiment of the system, the receive signal strength and/or link quality index indicators may be replaced with timing information about when the message(s) are received. This may be used to determine the location of asset tag 2 through the use of a time-delay algorithm.

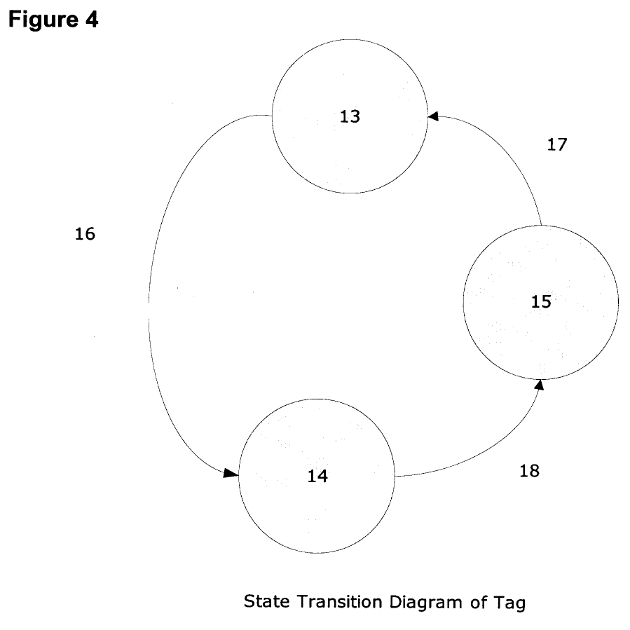

Reference is now made to FIG. 4, which depicts the states of operation for a wireless tag. In this embodiment, an accelerometer is used to detect when the tag is stationary and when it is in motion. In this instance, there are 3 states of operation: in-motion state 13, stopped state 14, and stationary state 15. When the tag is in the in-motion state 13, it will periodically send out a message containing its identification code and any other status information that is configured to be sent. The frequency of this message is variable and can be set by the user. First transition 16 from the in-motion state 13 to the stopped state 14 occurs when the tag detects that it has stopped moving. When a tag enters the stopped state 14 it will perform the locating communications sequence as identified before. It will first broadcast out a packet and then listen for responses. Once all the responses have been received, it will transmit a single message with all the responses. This locating communications sequence will repeat itself for a period of time as defined by the user.

Second transition 18 from the stopped state 14 to the stationary state 15 occurs when the time since entering the stopped state 14 exceeds the user-defined time for being in the stopped state 14. When the tag is in the stationary state 15, it may periodically send out a message containing its identification code and any other status information that is configured. The frequency of this message is variable and can be set by the user. The frequency of this message may be the same or different from the frequency of the message sent when the tag is in the in-motion state 13. Once the tag begins moving again, the tag changes from the stationary state 15 to in-motion state 13 through third transition 17.

In another embodiment of the system, the transition from a waiting state to a locating state may be a command sent to the tag from an external source. In this embodiment, there would be only two states: the waiting state and the locating state. The locating state would be the state that a tag enters when it first detects the command. This would cause the locating communications sequence to be initiated. When the time since entering the locating state has exceeded the time set by the user, the tag will enter the waiting state.

In yet another embodiment of the system, the trigger may be a temperature sensor that detects a change in temperature relative to a threshold. In this instance there would exist three states: the below-threshold state, the locating state, and the above-threshold state. The following example describes the sequence of events when the temperature rises above the desired threshold. The transition from the below-threshold state and the locating state would occur when the temperature first rises above the pre-set threshold. The locating communications sequence would then occur. This locating communications sequence will repeat itself for a period of time as defined by the user. The transition from the locating state to the above-threshold state occurs when the time since entering the above-threshold state exceeds the user-defined time. The transition from the above-threshold state to the below-threshold state occurs when the temperature drops below the pre-set threshold.

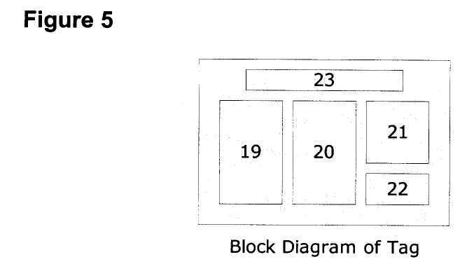

Reference is now made to FIG. 5, which depicts a wireless tag. The wireless tag may be a radio frequency identification tag. The functional components of the tag are as follows: a communications unit 19, a processor 20, an accelerometer 21, a battery 22, and an antenna 23. There may also be provided memory for storing data. In the case of the communications unit 19, it may be a single transceiver or a separate receiver and transmitter. Communications unit 19 is used to send and receive the radio frequency messages between the tags and the interrogator 4 and may be capable of variable, controlled-range transmission. Processor 20 is used to control the operation, timing, and logic of the tag. It may also implement and control power-saving features for the device. In one embodiment, the accelerometer 21 may be replaced with a sensor for sensing temperature, shock, humidity, air pressure, vibration, proximity of other objects, time, motion, or radio frequency. The battery 22 may be a single or a plurality of batteries. Battery 22 may also include a means to recharge itself through the use of additional circuitry contained on the device. Antenna 23 may be printed directly onto the circuit board or attached by means of a connector. Furthermore, there may be provided a single chip containing one or more of the functional components.

Tags may have the ability to be configured to transmit and receive messages at a single or plurality of radio frequencies. One example of this would be where the system is configured such that the frequency used for tag-to-tag communications is at one frequency and the frequency used for tag-to-interrogator communications is at a different frequency. Tags may also have to the ability to be configured to transmit and receive messages at a single or plurality of power levels. All tags may have several and independent configuration settings for frequency, transmit power, receive sensitivity, and other settings.

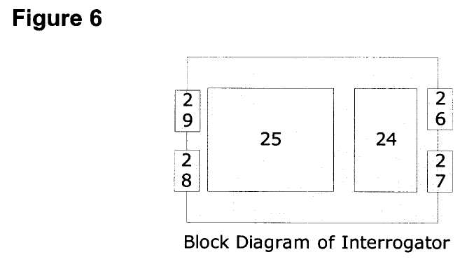

Reference is now made to FIG. 6, which depicts the interrogator 4. Interrogator 4 transmits messages received from tags to a backend system. It acts as the conduit for information to be relayed to the backend system capable of analyzing the data and containing one or more algorithms to determine the location of the asset tag 2. The functional components of the interrogator 4 are as follows: an interrogator communications unit 24, a processor 25, an antenna 26, a serial port 28, an Ethernet port 27, and a power connector 29. In the case of the interrogator communications unit 24, it may be a single transceiver or a separate receiver and transmitter.

Interrogator communications unit 24 is used to send and receive radio frequency messages to and from tags. Processor 25 is used for the control the operation, timing, and logic of the interrogator 4. Antenna 26 may be printed directly on the circuit board, or attached by means of a connector. Ethernet port 27 provides one possible means of data transmission to the backend system. In another embodiment, the Ethernet port 27 may be replaced with a component for wireless capability. Examples of wireless capability include, but are not limited to, 802.11, cellular, or VHF radio. Serial port 28 may also be used for data transmission to a backend system. Power connector 29 provides connection to a voltage source to enable operation of the device. In another embodiment, this power may be received by means of the Ethernet port 27 capable of power over Ethernet support. Furthermore, there may be provided a single chip containing one or more of the functional components. There may be more than one interrogator 4.

Interrogator 4 can be installed either at a fixed location or on a mobile device. Where the interrogator 4 is installed at a fixed location, it will be installed on a part of the environment that is fixed and permanent. Interrogator 4 may also be installed on a mobile device such as a fork truck, cart, vehicle, or other mobile device.

Reference location tag 3 is a tag that is in a known space within the system. Reference location tag 3 may be installed on some part of the infrastructure of the environment that is permanently fixed. An example of this would be a beam, pole, wall, in the floor, racking, or other fixed piece of the structure of the environment. Alternatively, tags that are on assets in the environment that have known locations may act as a reference location tag as long as their locations are known. There is no need for the reference location tags 3 to be located equidistance from one another.

Assets within the system each may have a single or plurality of asset tags 2 affixed to them.

All tags within the system may be equipped with a sensor that permits the tag to know when a particular event has occurred. Many different types of sensors may be used for this purpose, such as a proximity sensor, a timer, a sensor for detecting a received transmission, or a temperature sensor.

The system makes use of the described sensors to reduce the amount of RF communications that takes place. The sensors may be used to determine when the tag should begin communications. In one embodiment of this system, a motion sensor will be used to detect when a tag is in motion or stopped. In this embodiment, the locating communications sequence will take place only when the tag comes to a stop. This locating communications sequence will continue for a preset amount of time and then the tag will then halt the sequence.

An example of the above embodiment is a system where the assets are trailers being manufactured. When the trailer is moved, the asset tag attached to the trailer detects that it is in motion and then detects that it has come to rest. Upon detecting that the tag, and therefore the trailer, has come to rest, the tag performs a locating communications sequence for 30 seconds and then stops all RF communications.

To reduce the occurrence of signal collisions resulting in a loss of data exchange, the communication signals may be transmitted with an anti-collision algorithm that is directly correlated to the identification code of the tags. The anti-collision algorithm is intended to limit the occurrence of two or more RF communications taking place at the same instant in time. When a tag is required to transmit a message, it will delay the transmission by a number of milliseconds. This delay may be equal to the last two or three digits of the serial number of the tag, which may be reflected in the unique identification code of the tag. The number of digits used may depend on the implementation of the system.

1. A method for collecting data from wireless tags comprising the steps of:
providing a plurality of wireless tags each capable of transmitting and receiving data and each identified by a unique identification code;
a first one of said wireless tags transmitting data;
at least one other one of said wireless tags receiving said data and responding by transmitting further data including information relating to its unique identification code;
said first wireless tag receiving said further data;
said first wireless tag transmitting still further data including information relating to the unique identification code of said first wireless tag and information relating to the unique identification codes of each of said responding wireless tags; and
a receiving unit receiving said still further data.

2. The method of claim 1, wherein said step of said first wireless tag transmitting data is initiated by one or more of the following events: a receipt of a signal by said first wireless tag from said receiving unit; a receipt of a signal by said first wireless tag from said other wireless tag; a receipt of a signal from a timer; a receipt of a signal from a sensor; and a transition of said first wireless tag from a moving state to a stationary state.

3. (canceled)

4. The method of claim 1, wherein said wireless tags are radio frequency identification tags and wherein said receiving unit is an interrogator.

5. (canceled)

6. A method for determining the location of a subject wireless tag capable of transmitting and receiving data, comprising the steps of:
providing at least one other wireless tag capable of transmitting and receiving data and identified by an unique identification code;
said subject wireless tag transmitting data;
said at least one other wireless tag receiving said data and responding by transmitting further data including information relating to its unique identification code;
said subject wireless tag receiving said further data;
said subject wireless tag transmitting still further data including information relating to the unique identification codes of each of said at least one other wireless tag;
a receiving unit receiving said still further data;
said receiving unit processing said still further data to determine the location of said subject wireless tag.

7. The method of claim 6, wherein said step of said wireless tag transmitting data is initiated by one or more of the following: a receipt of a signal by said wireless tag from said receiving unit; a receipt of a signal by said first wireless tag from said other wireless tag; a receipt of a signal from a timer; a receipt of a signal from a sensor; and a transition of said wireless tag from a moving state to a stationary state.

8. (canceled)

9. (canceled)

10. The method of claim 6, wherein said wireless tags are radio frequency identification tags.

11. The method of claim 10, wherein said receiving unit is an interrogator.

12. The method of claim 6, wherein said step of said at least one other wireless tag transmitting further data further comprises transmitting information relating to the signal strength of said data received by said at least one other wireless tag.

13. (canceled)

14. The method of claim 12, wherein said step of said subject wireless tag transmitting still further data further comprises transmitting information relating to the signal strength of said further data received by said subject wireless tag.

15. (canceled)

16. (canceled)

17. (canceled)

18. (canceled)

19. (canceled)

20. The method of claim 6, wherein said subject wireless tag comprises a transmitter capable of variable, controlled-range transmission.

21. The method of claim 6, wherein said at least one other wireless tag comprises a transmitter capable of variable, controlled-range transmission.

22. The method of claim 6, further comprising the steps of measuring with a sensor located on said subject wireless tag one or more of the following attributes of said subject wireless tag: temperature, air pressure, humidity, vibration, shock, motion, proximity of other objects, and current time; and said subject wireless tag transmitting information relating to said one or more attributes.

23. (canceled)

24. (canceled)

25. The method of claim 6, wherein said step of said subject wireless tag transmitting still further data further comprises one or more of the following:
transmitting at a different frequency than said step of said subject wireless tag transmitting data;
transmitting at a different power level than said step of said subject wireless tag transmitting data; and
transmitting information relating to the identification of said subject wireless tag.

26. (canceled)

27. (canceled)

28. A location tracking system for wireless tags comprising:
a wireless tag capable of transmitting and receiving data;
at least one other wireless tag capable of receiving data from said wireless tag and transmitting data to said wireless tag, wherein the data transmitted to said wireless tag by each of said at least one other wireless tag comprises information relating to the identification of each said at least one other wireless tag and information relating to the signal strength between said wireless tag and each of said at least one other wireless tag;
a receiving unit capable of receiving data from said wireless tag, wherein the data received from said wireless tag comprises information relating to data received by said wireless tag from each said at least one other wireless tag; and
processing means to compute the location of said wireless tag from the data received by said receiving unit.

29. The system of claim 28, wherein said data received from said wireless tag by said receiving unit further comprises information relating to the identification of said wireless tag.

30. The system of claim 28, wherein said wireless tags are radio frequency identification tags.

31. The system of claim 30, wherein said receiving unit is an interrogator.

32. (canceled)

33. A wireless tag for a location tracking system comprising:
a transmitter operable to transmit initial data to at least one other wireless tag and operable to transmit accumulated data to a receiving unit, wherein said accumulated data comprises information relating to the identification of said at least one other wireless tag and information relating to the signal strength between said wireless tag and said at least one other wireless tag;
a receiver operable to receive response data from each of said at least one other wireless tag, wherein said response data comprises information relating to the identification of each of said at least one other wireless tag and information relating to the signal strength between said wireless tag and each of said at least one other wireless tag;
a controller comprising:
means to cause said transmitter to begin transmission of said initial data; and
a processor to transform said response data received by said receiver from each of said at least one other wireless tag into said accumulated data.

34. The wireless tag of claim 33, wherein said accumulated data further comprises information relating to the identification of said wireless tag.

35. The wireless tag of claim 33, wherein said means to cause said transmitter to begin transmission of said initial data comprises computer logic to begin transmission upon a triggering event, wherein said triggering event is one or more of the following: a receipt of a signal from said other wireless tag; a receipt of a signal from a timer; a receipt of a signal from a sensor; a receipt of a signal from said receiving unit; and a transition of said wireless tag from a moving state to a stationary state.

36. (canceled)
